(19) United States
(12) Patent Application Publication
(10) Pub. No.: US 2020/0398243 A1
(43) Pub. Date: Dec. 24, 2020

(54) LIGHT AEROGEL MATERIAL AND PREPARATION METHOD THEREOF

(71) Applicant: Yuxin WANG, Ningbo (CN)

(72) Inventor: Yuxin WANG, Ningbo (CN)

(21) Appl. No.: 16/993,238

(22) Filed: Aug. 13, 2020

Related U.S. Application Data
(63) Continuation of application No. PCT/CN2019/078063, filed on Mar. 14, 2019.

(30) Foreign Application Priority Data
Mar. 23, 2018 (CN) 201810243299.1

(51) Int. Cl. B01J 13/00; C01B 33/158; A01K 1/015

(52) U.S. Cl. CPC B01J 13/0091; C08J 2205/026; A01K 1/0152; C01B 33/1585

(57) ABSTRACT

The present disclosure provides a lightweight aerogel material including a polymer and clay. The lightweight aerogel material in the present disclosure may be a lightweight and strong absorbent material prepared by mixing the clay, hydrophilic polymer, and other inorganic raw materials that may be added, adding water to the mixture as a medium, stirring the mixture at a high speed to become viscous, and lyophilizing the mixture. The lightweight aerogel material prepared in this manner may have a micron-sized and nano-sized pores, which contributes to the high water absorbency and water absorption rate. When the lightweight aerogel material is used as cat litter, the water absorbency and water absorption rate of the cat litter may be much higher than the similar products. Furthermore, the density of the lightweight aerogel material in the present disclosure is controllable, which may meet the needs for different applications including the cat litter. Moreover, the lightweight aerogel material may be crushed to obtain irregular structures with rough surfaces, or may be formed into various special shapes through mold freezing.

### CROSS-REFERENCE TO RELATED APPLICATIONS

This application is a continuation of International Application No. PCT/CN2019/078063, filed on Mar. 14, 2019, which claims priority of Chinese Patent Application No. 201810243299.1 filed on Mar. 23, 2018, the entire contents of each of which are hereby incorporated by reference.

### TECHNICAL FIELD

The present disclosure generally relates to a lightweight aerogel material and a preparation method thereof, and more specifically, relates to a lightweight aerogel material with high water absorbency and absorption rate, and a preparation method thereof.

### BACKGROUND

Cat litter, commonly known as pet toilet paper, is a daily necessity for regular families with pets. In addition, the cat litter is also used in pet shops and pet breeding farms. With a huge consumption as a pet supply, the cat litter can absorb waste such as pet urine and feces, and prevent odor spillover. The importance of the cat litter in the entire pet market is second only to cat food. When in use, a cat litter box is filled with 7 cm to10 cm of the cat litter, then it can be used for cats. When cleaning the cat litter box, a cat litter shovel may be used to shovel the clumps of the cat litter out. The clumps may be thrown to a trash can. The remaining cat litter in the cat litter box is still clean and can be used continuously.

Common cat litter products come in a wide variety of materials with bases made from bentonite montmorillonite cat litter, pine cat litter, silica gel cat litter, and degradable cat litter, such as paper cat litter and tofu cat litter. The cat litter made from bentonite and montmorillonite are small and fine particles, which may have a low absorption capacity, and may be easily attached to the cat and then be taken out of the cat litter box. In addition, the cat litter made from bentonite and montmorillonite has a heavy mass, which may result in a large amount of consumption and waste. The pine cat litter is second only to earth sand in term of the amount consumed. Due to the limitations of raw materials and preparation processes, the pine cat litter itself has an odor. Almost all pine cat litter products contain formaldehyde, which may impose a hidden danger to the health of cats. The silica gel cat litter has a high water absorption capacity. However, heat will be discharged rapidly during the absorption process. If the heat, limited by the pore sizes of the silica gel cat litter, cannot be effectively discharged, a pressure difference between inside and outside of a particle of the silica gel cat litter may cause the particle to burst. Furthermore, the fine particles of the silica gel cat litter may be easily caught in between the cat's palm pads and cause injury. The degradable paper cat litter may effectively combine recycled pulp and polymers, which may instantly coagulate into clumps, and strongly absorb water to deodorize. However, the particles of the paper cat litter may be too light to be easily accepted by some cats. The tofu cat litter, which contains tofu residue, is an environmentally-friendly cat litter. The tofu cat litter has the advantage of low dustiness but has the disadvantage of poor clumpability and water absorption capacity. In addition, the tofu cat litter is generally added with perfumes and preservatives, which may not be easily accepted by some cats.

According to usage characteristics, the cat litter may include non-clumping cat litter and clumping cat litter. The traditional non-clumping cat litter is limited to providing an excretion place to a cat. However, because of poor clumpability and water absorption capacity, the non-clumping cat litter may usually be used once or a limited number of times, then the entire box of cat litter may need to be replaced. To solve this problem, the clumping cat litter emerged with a high water absorption capacity, which may quickly absorb the moisture and urine in the feces and in return clump. When the clumping cat litter in the cat litter box is gradually consumed, the clumped cat litter may be removed and new clumping cat litter may be added at any time, without the need to replace the entire box of the clumping cat litter.

The criteria for evaluating the performance of the cat litter may include clumpability, water absorption capacity, and dustiness. The clumpability of the cat litter is related to the water absorption capacity. The water absorption capacity may include two important indicators—a water absorption rate and a water absorption amount. Cat litter with a high water absorption rate and a large water absorption amount per unit mass may have better clumpability. The dustiness of the cat litter may be mainly affected by the particle sizes and strength of the cat litter. Cat litter with small particle sizes, an uneven distribution, and a poor strength will produce more dust during production and use. Therefore, the cat litter need to have relatively large particle sizes, a uniform distribution, and a high strength. However, the cat litter with large particle sizes may be easy to cause the liquid to flow to the bottom of the cat litter box. In such cases, the water absorption rate and the water absorption amount become major indicators for evaluating the quality of the cat litter.

Therefore, the technical problem that needs to be solved urgently in this field is to find a high-quality material with a high water absorption rate, a large water absorption amount, and advantages of a controllable density, low dustiness, and environment friendly, which may be applied to the cat litter or have other suitable uses.

### SUMMARY

The present disclosure solves a problem of lack of a high-quality material suitable for the cat litter with a high water absorption rate and a large water absorption amount in the prior art, and further provides an environmentally-friendly lightweight aerogel material with a high water absorption rate, a large water absorption amount, a controllable density, and low dustiness. The present disclosure also provides a method for preparing the lightweight aerogel material.

The technical solutions adopted in the present disclosure to solve the above technical problems may include:

A lightweight aerogel material including 10-50 parts by weight of a polymer and 10-50 parts by weight of clay. The lightweight aerogel material may have micron-sized pores and a nano-layered structure.

A density of the lightweight aerogel material may be in the range of 0.1-0.5 g/cm³.

The polymer may include one or more of pectin, chitosan, polyvinyl alcohol, biocellulose, plant cellulose, starch-modified water absorbent resin, or acrylic water absorbent resin.

The polymer may include at least one of the starch-modified water absorbent resin and or the acrylic water absorbent resin. Average particle diameters of the starch-modified water absorbent resin and the acrylic water absorbent resin may be in the range of 1-100 μm.

The clay may include montmorillonite, kaolin, bentonite, attapulgite, or any combination thereof.

The lightweight aerogel material may further include an additive.

The additive may include at least one of an inorganic filler and an adsorbent. The inorganic filler may include straw powder, such as corn straw, wheat straw, cotton straw, rice straw, or any combination thereof. The adsorbent may include activated carbon, coral reef powder, alginate and derivatives thereof, or any combination thereof.

The additive may include a color indicator for cat urine or feces detection.

The color indicator used for cat urine or feces detection may include a pH color indicator or an enzyme color indicator.

The additive may include perfume, dye, antibacterial deodorant, or any combination thereof.

A method for preparing the lightweight aerogel material, including: (1) mixing a specified part by weight of the polymer and a specified part by weight of the clay, adding water to the mixture as a medium, and stirring the mixture to become viscous; (2) freezing the mixture at a temperature of −10 to −190° C. to become solid; (3) lyophilizing the mixture at a temperature of 20 to 30° C. until a water content of the mixture is 3-5 wt % to obtain the lightweight aerogel material.

The method may further include crushing the lyophilized mixture to obtain the lightweight aerogel in granular form.

The method may further include placing the viscous mixture in a granulated mold in step (1) followed by step (2).

The method may further includes mixing the specified part by weight of the polymer and the specified part by weight of the clay together with an additive in step (1).

The lightweight aerogel material may be used as cat litter and may have a particle size in the range of 5-25 mm.

The advantages of the lightweight aerogel material described in the present disclosure are as follows.

The lightweight aerogel material provided in the present disclosure may include a polymer and clay. The lightweight aerogel material provided in the present disclosure may have micron-sized pores and a nano-layered structure, which makes the lightweight aerogel material with a very high water absorbency and a high water absorption rate. When the lightweight aerogel material is used as cat litter, a particle size of the lightweight aerogel material may be from 5 to 25 mm. The water absorption amount and water absorption rate of the cat litter may be much higher than similar products.

The lightweight aerogel material in the present disclosure may be a lightweight and strong absorbent material prepared by mixing the clay, hydrophilic polymer, and other inorganic raw materials that may be added, adding water to the mixture as a medium, stirring the mixture at a high speed to become viscous, and lyophilizing the mixture. The lightweight aerogel material prepared in this way may have a special micron-sized and nano-sized pores. Moreover, a density of the lightweight aerogel material in the present disclosure is controllable, which may meet the needs of different occasions including the cat litter.

Because the lightweight aerogel material in the present disclosure has been lyophilized, its micro-porous structure may make it have a very suitable roughness, which is in line with cats' pit-digging nature and is easier to be accepted by the cats than cat litter with a smooth surface.

As an alternative embodiment, a particulate lightweight aerogel material may be prepared by directly crushing the lyophilized mixture in the present disclosure, or by placing the viscous mixture in a granulated mold in step (1) followed by step (2). Both of the two operations may be used to obtain the particulate lightweight aerogel material suitable for cat litter. As an alternative embodiment, the particulate lightweight aerogel material may have any shape including an irregular shape, a regular shape such as a cylindrical, a square, a long strip, or the like. The lightweight aerogel material in the present disclosure, on the basis of retaining the high absorption capacity of clay, may be added with water-soluble polymers. After absorbing water, the lightweight aerogel material may be directly discharged into a sewer or be reactivated by a simple method and reused. At the same time, due to hydrophilic and degradable properties of the polymer, the lightweight aerogel material in the present disclosure may be naturally biodegradable and no waste is generated during the biodegradation process when using environmentally friendly materials, thereby solving the problem of environmental pollution.

The lightweight aerogel material in the present disclosure is preferably added with a color indicator for cat urine or feces detection. The color indicator may include a pH color indicator or an enzyme color indicator. The lightweight aerogel material in the present disclosure is prepared by lyophilizing, which may not destroy the activity of the color indicator, especially the enzyme color indicator, and ensure a stable color fixation of the color indicator and not easy to precipitate. When the lightweight aerogel material added with the color indicator is used as cat litter, the urine of cats may be detected to help determine whether a disease occurs. At the same time, due to the stability of color fixation of the color indicator, the lightweight aerogel material will not be discolored during use, and the cat's fur will not be stained by the color indicator.

The above summary is only for the purpose of description and is not intended to be limiting in any way. In addition to the schematic aspects, embodiments, and features described above, further aspects, embodiments, and features of the present disclosure will be readily apparent by reference to the drawings and the following detailed description.

### BRIEF DESCRIPTION OF THE DRAWINGS

These embodiments are non-limiting exemplary embodiments, in which like reference numerals represent similar structures throughout the several views of the drawings. The drawings are not to scale. It should be understood that these drawings depict only some embodiments disclosed according to the present disclosure and should not be considered as limiting the scope of the present disclosure, and wherein:

FIG. 1 is a microstructure view of a lightweight aerogel material prepared according to Embodiment 3 of the present disclosure taken with a scanning electron microscope; and

FIG. 2 is a microstructure view of the lightweight aerogel material prepared according to Embodiment 3 of the present disclosure taken with a transmission electron microscope.

### DETAILED DESCRIPTION

In the following description, certain exemplary embodiments are simply described. Various modifications to the disclosed embodiments will be readily apparent to those skilled in the art without departing from the spirit and scope of the present disclosure. Thus, the drawings and the description are merely provided for the purpose of illustration, and not intended to limit the scope of the present disclosure.

In the description of the present disclosure, unless otherwise stated, the term “a plurality of” means two or more.

In the following embodiments, 1 part by weight represents 10 g.

### Embodiment 1

The lightweight aerogel material described in this embodiment may include 20 parts by weight of a polymer and 30 parts by weight of clay. In this embodiment, the polymer may be pectin and the clay may be montmorillonite. The method for preparing the lightweight aerogel material may include the following steps:

(1) 20 parts by weight of pectin, 30 parts by weight of montmorillonite, and 1 part by weight of an antibacterial agent were mixed at room temperature. 100 parts by weight of water were added and the mixture was heated to 40 degrees Celsius. Then the mixture was stirred in a blender at a speed of 450-500 rpm for 10 min to obtain a hydrogel with a certain viscosity. In this embodiment, the antibacterial agent may be a bamboo extract.

(2) the hydrogel obtained in step (1) was poured into a flat plate. The thickness of the hydrogel in the flat plate may be 10 mm. The flat plate was put in a freezing room at minus 40 degrees Celsius for 12 h.

(3) the flat plate was put in a lyophilizer, the temperature and the pressure in the lyophilizer were set to 25 degrees Celsius and 40 Pa, respectively. The hydrogel was lyophilized for 24 h to obtain an aerogel. When the water content of the hydrogel in the flat plate was 5 wt % in mass percentage, the flat plate was taken out.

(4) the lyophilized aerogel was put in a crusher and crushed into small aerogel pieces with sizes of 15-20 mm. The small pieces of the aerogel may be lightweight aerogel materials with a density of 0.5 g/cm3.

### Embodiment 2

The lightweight aerogel material described in this embodiment may include 15 parts by weight of a polymer and 35 parts by weight of clay. In this embodiment, the polymer may be an acrylic water absorbent resin with particle sizes in the range of 1-100 μm. The clay may be kaolin. The method for preparing the lightweight aerogel material may include the following steps:

(1) 15 parts by weight of acrylic water absorbent resin, 35 parts by weight of kaolin, and 1 part by weight of an adsorbent were mixed at room temperature. 250 parts by weight of water were added and the mixture was heated to 40 degrees Celsius. Then the mixture was stirred in a blender at a speed of 300-400 rpm for 30 min to obtain a suspension. In this embodiment, the adsorbent may be activated carbon with particle sizes in the range of 200-300 μm.

(2) the suspension obtained in step (1) was poured into a flat plate. A thickness of the suspension in the flat plate may be 20 mm. The flat plate was put in a freezing room at minus 70 degrees Celsius for 2 h.

(3) the flat plate was put in a lyophilizer, the temperature and the pressure in the lyophilizer were set to 25 degrees Celsius and 40 Pa, respectively. The suspension was lyophilized for 24 h to obtain an aerogel. When the water content of the suspension in the flat plate was 5 wt % in mass percentage, the flat plate was taken out.

(4) the lyophilized aerogel was put in a crusher and crushed into small aerogel pieces with sizes of 10-15 mm. The small aerogel pieces may be lightweight aerogel materials with a density of 0.2 g/cm3.

### Embodiment 3

The lightweight aerogel material described in this embodiment may include 10 parts by weight of a polymer and 40 parts by weight of clay. In this embodiment, the polymer may be plant cellulose, and the clay may be bentonite. The method for preparing the lightweight aerogel material may include the following steps:

(1) 10 parts by weight of plant cellulose, 40 parts by weight of bentonite, 0.5 part by weight of an adsorbent, and 0.5 part by weight of a colorant were mixed at room temperature. 450 parts by weight of water were added and the mixture was heated to 30 degrees Celsius. Then the mixture was stirred in a blender at a speed of 450-500 rpm for 30 min to obtain a suspension. In this embodiment, the adsorbent may be activated carbon, and the colorant may be β-carotene.

(2) the suspension obtained in step (1) was poured into a flat plate. A thickness of the suspension in the flat plate may be 20 mm. The flat plate was put in a liquid nitrogen solution at minus 190 degrees Celsius for 2 h.

(3) the flat plate was put in a lyophilizer, the temperature and the pressure in the lyophilizer were set to 25 degrees Celsius and 40 Pa, respectively. The suspension was lyophilized for 24 h to obtain an aerogel. When the water content of the suspension is 5 wt % in mass percentage, the flat plate was taken out.

(4) the lyophilized aerogel was put in a crusher and crushed into small aerogel pieces with sizes of 5-10 mm. The small aerogel pieces may be lightweight aerogel materials with a density of 0.1 g/cm3.

### Embodiment 4

The lightweight aerogel material described in this embodiment may include 50 parts by weight of a polymer and 50 parts by weight of clay. In this embodiment, the polymer may be plant cellulose, and the clay may be bentonite. The method for preparing the lightweight aerogel material may include the following steps:

(1) 50 parts by weight of plant cellulose, 50 parts by weight of bentonite, and 0.1 parts by weight of a color indicator were mixed. 300 parts by weight of water were added and the mixture was heated to 30 degrees Celsius. Then the mixture was stirred in a blender at a speed of 450-500 rpm for 30 min to obtain a suspension. In this embodiment, the color indicator may be a pH color indicator, and exemplary pH color indicator may suitably include methyl red, bromocresol green, thymol blue, litmus, phenolphthalein, phenol red, or the like, or any combination thereof. In a preferred embodiment, the pH color indicator may be phenol red which has non-toxic and safe characteristics. In this embodiment, 0.1 part by weight of phenol red was added.

(2) the suspension obtained in step (1) was poured into a flat plate. The flat plate was put in a freezing room at minus 190 degrees Celsius for 2 h.

(3) the flat plate was put in a lyophilizer, the temperature and the pressure in the lyophilizer were set to a temperature of 25 degrees Celsius and 40 Pa, respectively. The suspension was lyophilized for 24 h to obtain an aerogel. When the water content of the suspension in the flat plate was 5 wt % in mass percentage, the flat plate was taken out.

(4) the lyophilized aerogel was put in a crusher and crushed into small aerogel pieces with sizes of 10-25 mm. The small aerogel pieces may be the lightweight aerogel material.

The lightweight aerogel material prepared in this embodiment can vary in colors when it encounters an acid solution or an alkali solution. When it is used as cat litter, the different colors can indicate a pH value of the urine of a cat. The pH value of the lightweight aerogel material added with phenol red in the present disclosure is about 6.5-8, which may meet the needs of cat urine detection. The lightweight aerogel material may be used to assist in determining whether a disease has occurred or whether there are hidden health risks, or may be used to assist in determining health status of a cat when it has diseases such as urinary system diseases.

### Embodiment 5

The lightweight aerogel material described in this embodiment may include 50 parts by weight of a polymer and 50 parts by weight of clay. In this embodiment, the polymer may be plant cellulose, and the clay may be bentonite. The method for preparing the lightweight aerogel material may include the following steps:

(1) 50 parts by weight of plant cellulose, 50 parts by weight of bentonite, and 0.1 parts by weight of a color indicator were mixed. 300 parts by weight of water were added and the mixture was heated to 30 degrees Celsius. Then the mixture was stirred in a blender at a speed of 450-500 rpm for 30 min to obtain a suspension. In this embodiment, the color indicator may be an enzyme color indicator, and an exemplary enzyme color indicator may include 0.005 part by weight of glucose oxidase, 0.005 part by weight of catalase, and 0.099 part by weight of tetramethylbenzidine (TMB).

(2) the suspension obtained in step (1) was poured into a flat plate. The flat plate was put in a freezing room at minus 190 degrees Celsius for 2 h.

(3) the flat plate was put in a lyophilizer, the temperature and the pressure in the lyophilizer were set to 25 degrees Celsius and 40 Pa, respectively. The suspension was lyophilized for 24 h to obtain an aerogel. When the water content of the suspension is 5 wt % in mass percentage, the flat plate was taken out.

(4) the lyophilized aerogel was put in a crusher to be crushed to obtain small aerogel pieces with sizes of 10-25 mm. The small aerogel pieces may be the lightweight aerogel material. In this embodiment, glucose may be decomposed into gluconic acid and hydrogen peroxide under the catalytic action of glucose oxidase, the hydrogen peroxide may be decomposed into water and atomic oxygen under the catalytic action of catalase, and discoloration may occur when the atomic oxygen encounters the tetramethylbenzidine. Thus, the lightweight aerogel material prepared in this embodiment will change color when a glucose component is detected, thereby assisting in determining whether a related disease occurs.

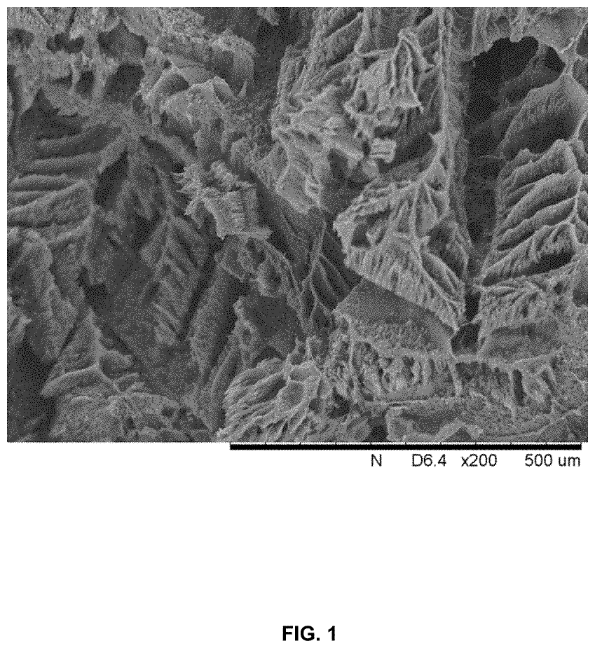

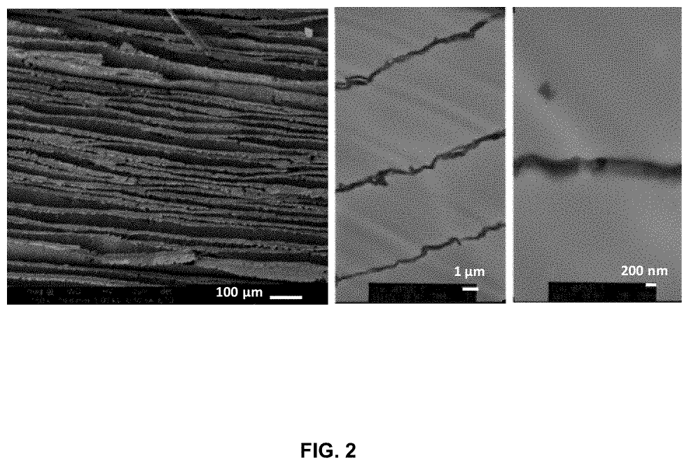

A microstructure of the lightweight aerogel material prepared in Embodiments 1-5 may be observed using a scanning electron microscope and a transmission electron microscope. The lightweight aerogel material prepared in Embodiments 1-5 may have micron-sized pores and a nano-layered structure. The nano-layered structure may be distributed on the pore wall of the micron-sized pores and between the pores. Taking Embodiment 3 as an example, FIG. 1 illustrates a microstructure view of the micron-sized pores of the lightweight aerogel material prepared in Embodiment 3 recorded by a scanning electron microscope. FIG. 2 illustrates a microstructure view of the nano-layered structure of the lightweight aerogel material prepared in Embodiment 3 scanned by a transmission electron microscope. For a lightweight aerogel material prepared in Embodiment 3, the pore size of the micron-sized pores may be in the range of 10-50 μm, and the thickness of the nano-layered structure may be in the range of 100-300 nm.

The above Embodiments 1-5 are exemplary implementations, the selection of raw materials may not be limited to the above implementations. As an alternative implementation, the clay used as the raw materials may include montmorillonite, kaolin, bentonite, attapulgite, or any combination thereof. The type of additive may also be arbitrarily selected. For example, the additive may include at least one of inorganic filler and adsorbent. The inorganic filler may include straw powder, such as corn straw, wheat straw, cotton straw, rice straw, or any combination thereof. The preferred addition amount of the inorganic filler may be 1-10 parts by weight. The adsorbent may include activated carbon, coral reef powder, alginate and its derivatives, or any combination thereof. The preferred addition amount of the adsorbent may be 0.5-1 part by weight. In addition, the additive may also include perfume, dye, antibacterial deodorant, or any combination thereof. As a preferred embodiment, the addition amount of the perfume, dye, and antibacterial deodorant may be not larger than 0.5 part by weight.

### Analytic Embodiment

The water absorption capacity of the lightweight aerogel material prepared in the above Embodiments 1-3 may be tested according to the following method for testing the water absorption capacity.

100 mL of lightweight aerogel material was obtained with a 100 mL straight measuring cylinder. The lightweight aerogel material was weighted and the weight was recorded as M₀. After soaked in water for 15 min, the lightweight aerogel material was taken out and weighted. The weight was recorded as M₁. The water absorption capacity may be calculated according to the formula: water absorption capacity=M₁/M₀)−1.

Each of the three kinds of lightweight aerogel materials prepared in Embodiments 1-3 may have a water absorption capacity larger than 6 grams per gram of lightweight aerogel material. And the product prepared in Embodiments 3 may have the highest water absorption capacity, which may reach 10 grams per gram of lightweight aerogel material.

### Comparative Experiment

10 g of the lightweight aerogel material prepared in Embodiments 1-3 of the present disclosure and ordinary cat litter sold on the market were obtained, wherein the ordinary cat litter sold on the market may be traditional bentonite cat litter.

The water absorption rates of the three kinds of lightweight aerogel materials prepared in Embodiments 1-3 were compared. For a lightweight aerogel material prepared in Embodiment 1 of the present disclosure, the time for absorbing 50 mL of water per 10 g of the lightweight aerogel material may be 40 seconds in average. For a lightweight aerogel material prepared in Embodiment 2 of the present disclosure, the time for absorbing 50 mL of water per 10 g of the lightweight aerogel material may be 35 seconds in average. For a lightweight aerogel material prepared in Embodiment 3 of the present disclosure, the time for absorbing 50 mL of water per 10 g of the lightweight aerogel material may be 25 seconds in average.

For the traditional bentonite cat litter, the time for absorbing 50 mL of water per 10 g of the traditional bentonite cat litter may be 50 seconds in average.

According to the comparison results, the lightweight aerogel material prepared in the present disclosure may have a better water absorption property, and may have higher water absorption capacity and water absorption rate than the conventional cat litter material.

It should be noted that the above description is merely provided for the purpose of illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. Thus, the present disclosure is not limited to the embodiments shown but is to be accorded the widest scope consistent with the claims.

1. A lightweight aerogel material comprising:
10-50 parts by weight of a polymer; and
10-50 parts by weight of clay, wherein the light aerogel material has micron-sized pores and a nano-layered structure.

2. The lightweight aerogel material of claim 1, wherein a density of the light aerogel material is in a range of 0.1-0.5 g/cm³.

3. The lightweight aerogel material of claim 1, wherein the polymer includes one or more of pectin, chitosan, polyvinyl alcohol, bio-cellulose, plant cellulose, starch-modified water absorbent resin, or acrylic water absorbent resin.

4. The lightweight aerogel material of claim 3, wherein the polymer includes at least one of the starch-modified water absorbent resin or the acrylic water absorbent resin, average particle diameters of the starch-modified water absorbent resin and the acrylic water absorbent resin being in a range of 1-100 μm.

5. The light aerogel material of claim 1, further includes an additive.

6. A method for preparing the light aerogel material of claim 1, comprising:
(1) mixing a specified part by weight of the polymer and a specified part by weight of the clay, adding water to the mixture as a medium, and stirring the mixture to become viscous;
(2) freezing the mixture at a temperature of −10 to −190° C. to become solid; and
(3) lyophilizing the mixture at a temperature of 20 to 30° C. until a water content of the mixture is 3-5 wt % to obtain the light aerogel material.

7. The of claim 6, further comprising
crushing lyophilized mixture to obtain the light aerogel in granular form.

8. The method of claim 6, further comprising
placing the viscous mixture in a granulated mold in step (1) followed by step (2).

9. The method claim 7, wherein mixing the specified part by weight of the polymer and the specified part by weight of the clay together with an additive in step (1).

10. The lightweight aerogel material prepared in claim 7, wherein the lightweight aerogel material is used as cat litter and has a particle size in a range of 5-25 mm.
